(19) United States
(12) Patent Application Publication
(10) Pub. No.: US 2017/0043285 A1
(43) Pub. Date: Feb. 16, 2017

(54) OIL-FILTER ASSEMBLY

(71) Applicant: MR Filtration Ltd., Namdong-Ku (KR)

(72) Inventor: Jeom Sam Yu, Nam-gu (KR)

(21) Appl. No.: 14/844,699

(22) Filed: Sep. 3, 2015

(30) Foreign Application Priority Data
Aug. 12, 2015 (KR) 10-2015-0113914

(51) Int. Cl. B01D 35/00

(52) U.S. Cl. CPC B01D 35/005

(57) ABSTRACT

An oil filter element comprises a first end cap having a central opening, a second end cap having a central opening and a filter medium joined to the first and second end caps. The first end cap has a closure element that is eccentrically disposed between the central opening and the periphery of the end cap and which extends axially outward from the end cap. The closure element has a finger portion which axially extends outward from the outer end of the closure element for engagement with a stop in the filter housing. A location adjustment mechanism is disposed in the filter medium adjacent to the central opening of the first end cap and operates to guide installation of the filter element in the filter housing.

### BACKGROUND OF THE INVENTION

This invention relates to an oil filter assembly, and more particularly a filter element to filter contaminated engine oil and which can be easily installed in an oil filter housing.

Generally, an internal combustion engine that is used as a power source for vehicles must use engine oil as a lubricant for smooth operation of its rotating and sliding parts. Such engine oil is stored at an oil pan at the bottom of an engine, and then after filtering through an oil filter by the pumping actions of an oil pump, it is supplied to each of the engine's sliding parts through the lubricating circuits that are formed in the engine to perform its lubricating function. The oil is recollected in the oil pan in a condition that includes contaminants such as metal particles from sliding parts of the engine, carbon generated from fuel burning, as well as oxides generated by heating and aging of the oil and dust that enters the engine cylinders along with the intake air. Such contaminates in the oil are filtered by the oil filter to maintain the engine oil in a clean state.

FIGS. 1-3 are illustrations of a known oil filter assembly. The housing (10) contains filter element 20 through which contaminated engine oil flows from the vehicle oil pump The housing consists of an upper housing (11) and a lower housing (12) threaded together. In addition, the filter element (20) that is accommodated inside said housing (10) consists of a filtering paper or medium (21) to filter the contaminated engine oil, an upper fixed element or end cap (23) and a lower fixed element or end cap (24) that are each joined to the upper and lower ends of said filtering paper (21).

For the oil filter assembly (1) as aforementioned, when engine oil flows into the housing (10), the engine oil is filtered as it passes through the filter element (20) and the filtering paper (21) and then supplied to the engine. Over time, the filter element (20) accumulates sediments and contaminants which result in reduced filtering efficiency. The filter element should be replaced periodically which requires unscrewing the upper housing (11) from the lower housing (12), removing the filter element (20) from the lower housing, inserting a new filter element into the upper housing and then threading the housing sections together. When the filter element is removed from the lower housing, the closure element (25) of the filter element that seals the drain hole (13) is removed from the drain hole to thereby allow engine oil remaining in the lower housing to drain through the drain hole.

The filter housing as shown in FIGS. 1-3 has a stop (14) adjacent to the drain hole (13) and which serves to engage the closure element (25) when rotated sufficiently inward of the housing and to align the closure element with the drain hole to permit insertion of the closure element into the drain hole as the upper housing is threaded into fully seated position in the lower housing.

During installation of the filter element, the lower end of the filter element engages and surrounds the protruding connecting tube (15) of the lower housing (12). The lower portion of the filter element rotates about the connecting tube until the closure element engages the stop (14) which prevents further rotation and which causes the filter element to slide downward along the connecting tube until the filter element is seated in the lower housing with the closure element in sealed relation in the drain hole. This rotation and sliding of the lower portion of the filter element in relation to the connecting tube is not always smooth and can hamper the easy installation of a replacement filter element.

### BRIEF SUMMARY OF THE INVENTION

The oil filter assembly according to the invention aims to provide an oil filter assembly that can reduce the time required for exchanging the filter element by making it easy and simple to assemble the filter element to the filter housing.

According to an embodiment of the invention, an oil filter element comprises a first end cap having a central opening, a second end cap having a central opening and a filter medium joined to the first and second end caps. The first end cap has a closure element that is eccentrically disposed between the central opening and the periphery of the end cap and which extends axially outward from the end cap. The closure element has a finger portion which axially extends outward from the outer end of the closure element for engagement with a stop in the filter housing. A location mechanism is disposed in the filter medium adjacent to the central opening of the first end cap and which operates to guide installation of the filter element in the filter housing. In one embodiment, the location adjustment mechanism comprises a spring mechanism disposed in the filter medium adjacent to the central opening of the first end cap, the spring mechanism having a normally open spring and a ring disposed in the central opening of the first cap. The ring is operative to engage an outer end or rim of a tube in the lower filter housing in which the filter element is installed and to move inward of the filter medium against the spring force of the spring during installation of the filter element in the lower housing. In another embodiment the location adjustment mechanism comprises adjustment elements joined to or integrally formed with a tubular support of the first end cap. The ends of the adjustment elements can engage the peripheral rim of the tube in the lower filter housing during installation of the filter element in the housing.

To install the filter element in the housing of the oil filter assembly, the second end cap is inserted into the upper housing which usually includes a tubular element which extends axially inward from the closed top of the upper housing and over which the central opening of the second end cap fits. The fit between the central opening and tubular element is sufficiently tight such that the filter element is retained on the tubular element of the upper housing as the upper housing is screwed together with the lower housing. As the housing sections are threaded together, the filter element moves inward toward the bottom of the lower housing the ring of the housing spring mechanism engages the outer end of the tube in the lower housing and moves inward against the spring force of the spring mechanism. The closure element rotates with the filter element as the upper and lower housings are threaded together until the finger portion of the closure element engages a stop in the bottom of the lower housing. When the finger portion engages the stop, further rotation of the filter element is prevented and the closure element remains in alignment with the drain hole in the bottom of the lower housing and the closure element is pushed into sealing engagement with the drain hole when the upper and lower housings are fully threaded together.

### BRIEF DESCRIPTION OF THE SEVERAL VIEWS OF THE DRAWINGS

FIG. 1 is an illustration of a known oil filter assembly with the filter element in a raised position;

FIG. 2 is a partial illustration of the bottom portion of the housing of FIG. 1;

FIG. 3 is an illustration of the oil filter assembly of FIG. 1 with the filter element in seated position;

FIG. 4 is an illustration of an oil filter assembly according to one embodiment of the invention;

FIG. 5 is an illustration of the filter element of the oil filter assembly according to one embodiment of the invention;

FIG. 6 is an exploded view of the location adjustment elements of the oil filter assembly of FIG. 5;

FIGS. 7a through 7c are illustrations of the filter element of FIG. 5 in successive stages of installation in a housing of the filter assembly;

FIG. 8 shows another embodiment of the oil filter element according to the invention; and

FIG. 9 shows the filter element of FIG. 8 in seated position.

### DETAILED DESCRIPTION OF THE INVENTION

The following, with reference to the figures, is a more detailed explanation about the oil filter assembly according to the invention.

The oil filter assembly (100) according to one embodiment of the invention is characterized by easy and simply assembly of the housing that accepts engine oil and the filter element that filters the contaminated engine oil.

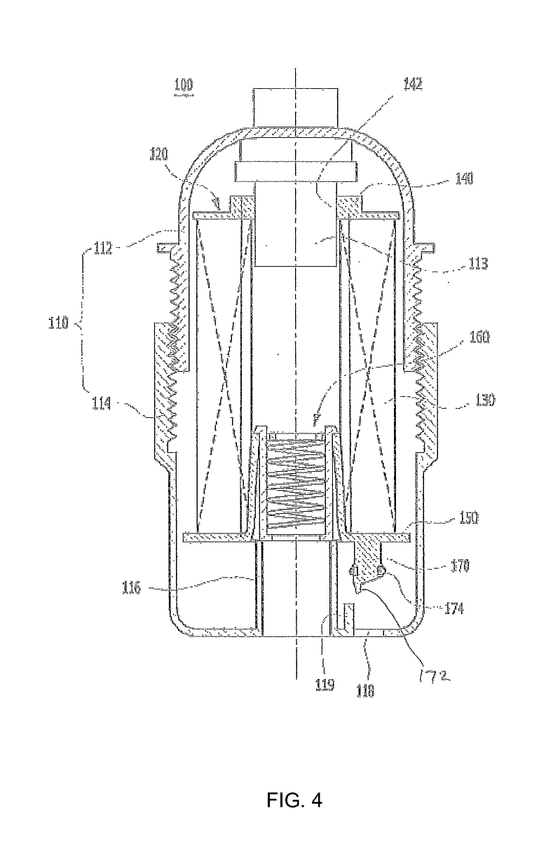

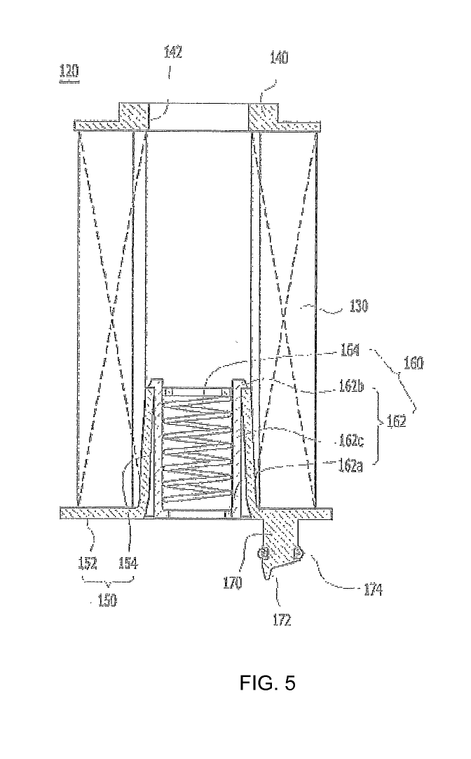

Referring to FIGS. 4 and 5, the oil filter assembly (100) according to one embodiment of the invention includes the housing (110) that accepts contaminated engine oil that flows in from a vehicle engine and the filter element (120) that filters the contaminated engine oil that flows into housing (110). The housing comprises an upper housing (112) and a lower housing (114) which can be threaded together.

The lower housing (114) has a protruded connection tube (116) to support said filter element (120) in sealed relation and into which oil is pumped during use of the filter assembly.

A drain hole (118) to discharge the engine oil pumped into the housing (110) is formed on one side of said lower housing (114) adjacent said connection (116). Said drain hole (118) discharges filtered engine oil to the vehicle lubrication system. A stop (119) is formed on one side of said drain hole (118) and protrudes in an upper direction. The stop (119) performs the function of situating the closure element (170) in alignment with the drain hole (118) when the finger portion (172) of the closure element (170) engages the stop to limit rotation of the filter element (120).

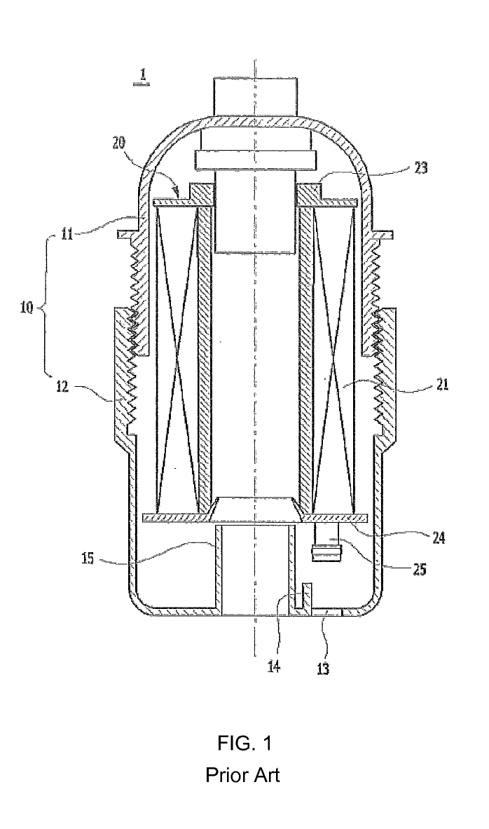

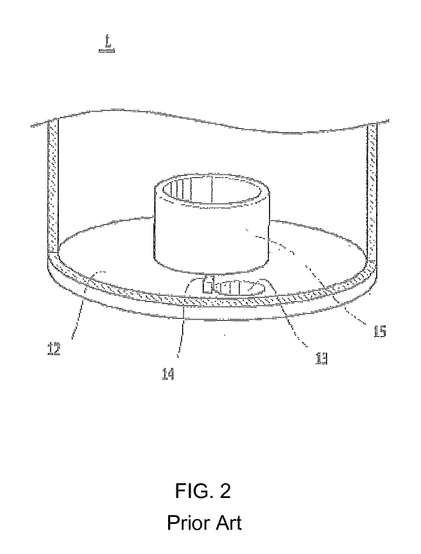

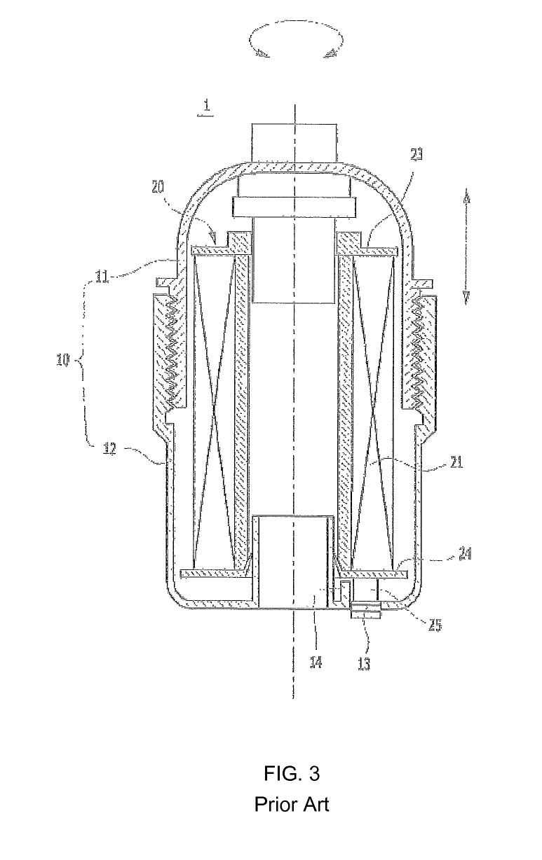

The filter element (120) that is installed inside housing (110) comprises an upper end cap (140) and lower end cap (150) that are joined in sealed relationship to a filter medium (130) which typically is formed of pleated paper. A center tube having an opening in the tube wall may be provided in an alternative embodiment and which joins the end caps and around which the filter medium is disposed. Such a center tube is per se known such as shown in FIG. 1.

The end cap 150 has an eccentrically disposed closure element (170) having an outwardly extending finger portion (172) and a sealing ring (174). The closure element and sealing ring are configured to fit into the drain hole (118) of the housing (114) and to seal the drain hole when the filter element is fully installed in the housing.

The end cap 140 has a central opening (142) which is sized to tightly fit around the protrusion (113) provided in the housing (112) to retain the filter element in the upper housing during installation of the filter element.

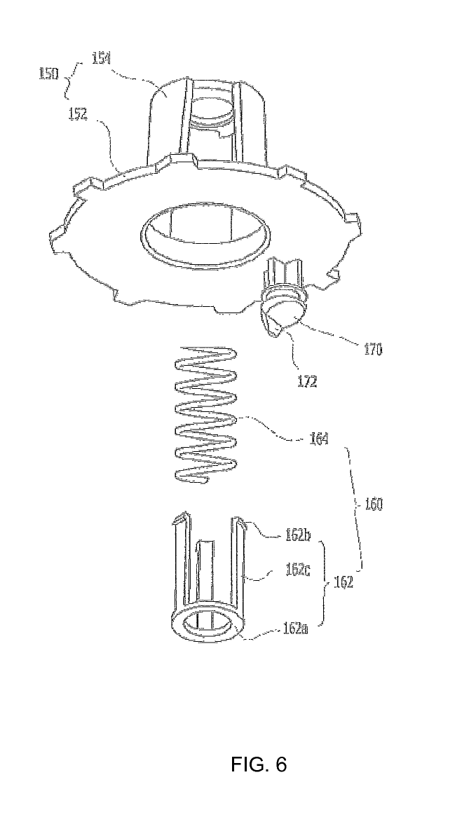

Referring to FIGS. 5 and 6, the end cap (150) comprises a plate (152) which supports the confronting end of the filter medium (130) and a tubular portion 154 which supports the confronting portion of the filter medium. A location adjusting mechanism (160) is disposed in the tubular portion (154) and in one embodiment comprises a coil spring (164) and a support (160) disposed around the spring and having a ring (162a) which is disposed within the central opening of end cap (150). The support includes legs (162c) which terminate at hooked ends (162b). The hooks fit over the inner end of tubular portion (152) to retain the support and spring in position within the tubular portion (154).

During installation of the filter element into the housing, the ring (162a) engages the confronting end or rim of the connection tube (116) and is pushed inward against the force of the spring (164) as the filter element is seated in the housing.

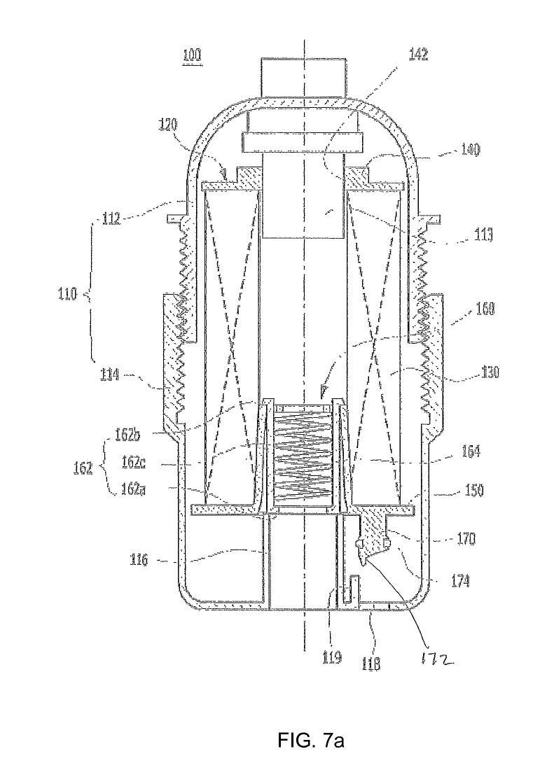

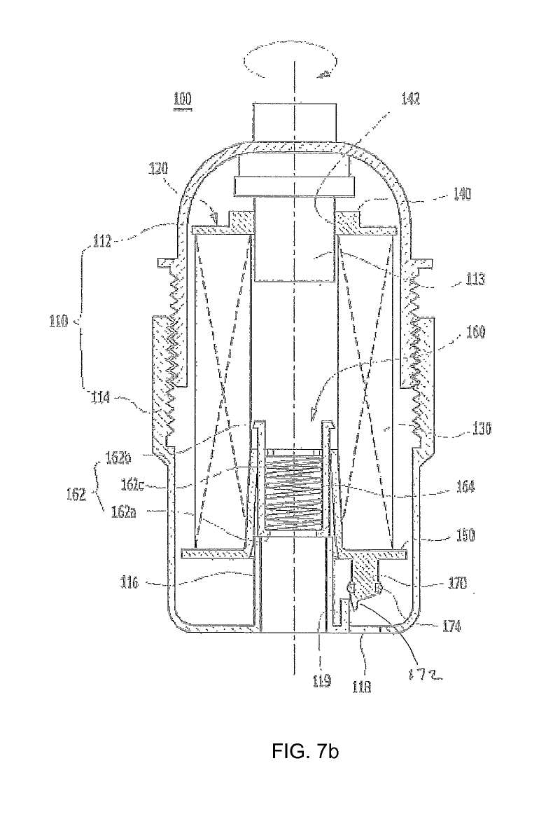

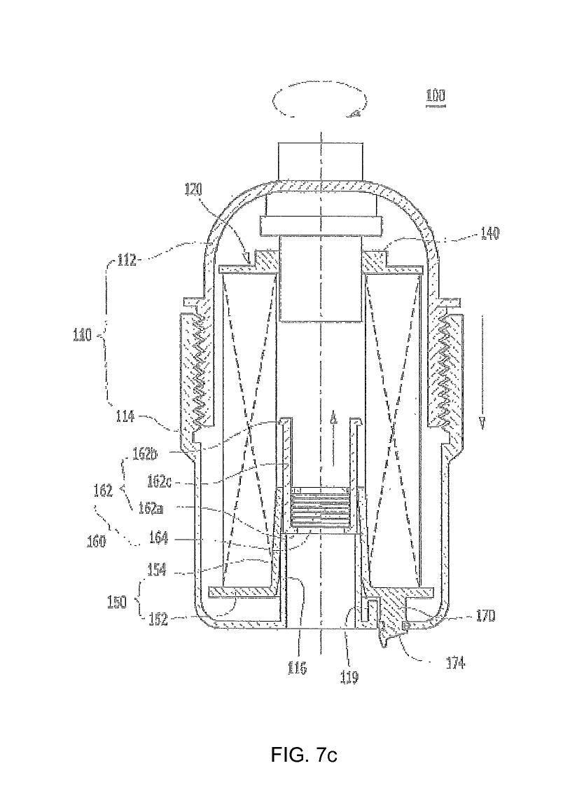

The disposition of the filter element in the housing as the housing sections are threaded together is illustrated in FIGS. 7a, 7b, and 7c. In FIG. 7a, the filter element is retained in the housing (112) and is shown with the ring (162a) in engagement with the confronting end of tube (116). FIG. 7b shows the housing sections further threaded together and the spring mechanism moved inward as the lower end of the filter element moves inward over tube (116). FIG. 7b also shows the finger element (172) in engagement with the stop (119). In this position, the filter element does not rotate further as the housings are threaded together. Rather, the filter element moves axially inward as the housings are threaded together until the housings are fully closed together as shown in FIG. 7c. In this position shown in FIG. 7c, the closure element (170) is seated in the drain hole and sealed thereto via the sealing ring (174). The spring mechanism (162) is pushed inward with the spring in a closed state.

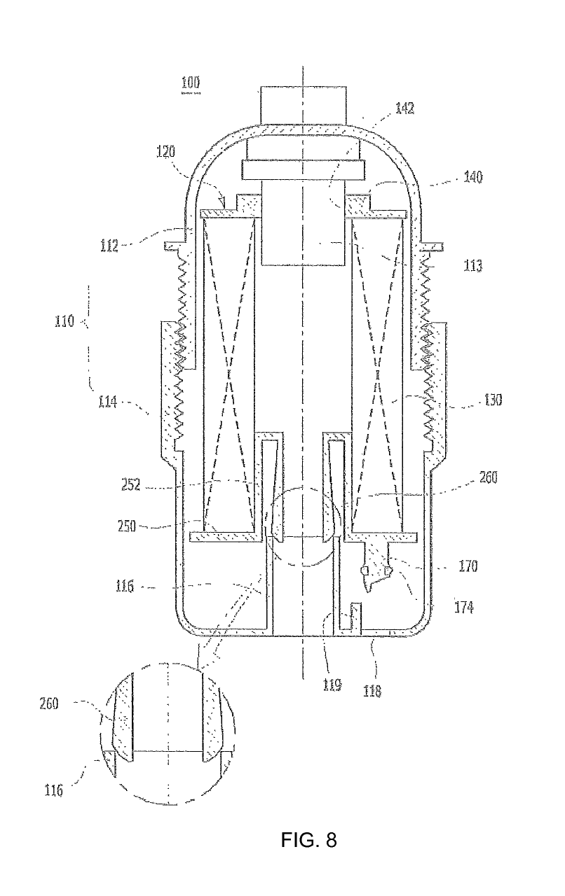

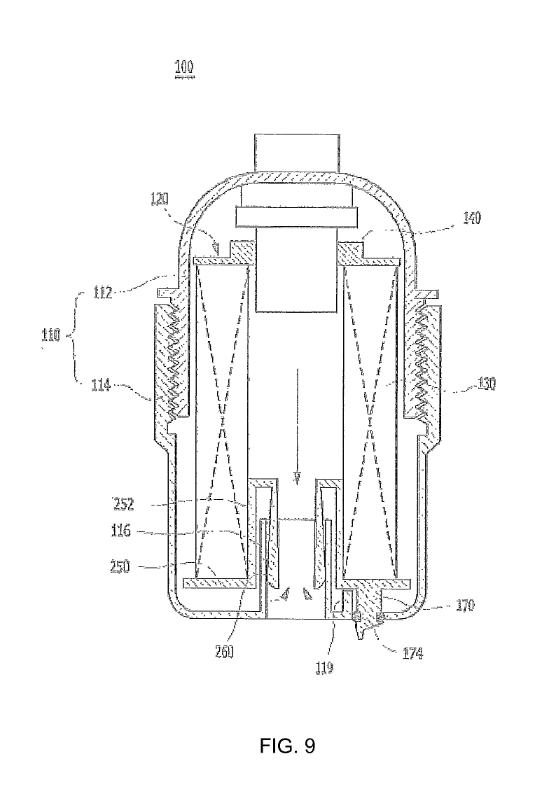

An alternative embodiment of the filter element is shown in FIGS. 8 and 9, in which the location adjustment mechanism has integrally formed adjustment elements (260) joined to a tubular support (252) of end cap (250). The outer ends of the adjustment element (260) are rounded and engage the inner peripheral edge or rim of connecting element (116), as illustrated in FIG. 8. As the housings are threaded together the adjustment element (260) moves into the connecting element (116) as shown in FIG. 9.

In both of the embodiments described above, the filter element is temporarily supported against the connecting tube (116) and guided downward into seating engagement in the housing when the housing sections are threaded together.

The invention is not to be limited to what has been particularly shown and described and is intended to encompass the spirit and full scope of the claims.

What is claimed is:

1. An oil filter assembly that connects a housing that accepts contaminated oil flowing in from a vehicle engine and a filter element that filters the contaminated oil, the filter element comprising:
a filter medium that filters the contaminated oil;
an upper end cap and a lower end cap that are each attached at respective upper and lower ends of said filter medium and configured to connect with said housing;
a location adjustment mechanism that is disposed in the filter medium adjacent the lower end cap and operates to guide installation of the filter element in said housing; and
a closure element to seal a drain hole in the housing when the filter element is sealed in the housing.

2. The filter element of claim 1 wherein the location adjustment mechanism includes:
a supporter slidably mounted in one end of the filter medium adjacent the lower fixed end cap;
a ring on the supporter disposed in the lower end cap; and
a spring in the supporter and operative to bias the supporter and ring in a normally outward position.

3. The filter element of claim 1 wherein the location adjustment mechanism includes:
a supporter mounted in one end of the filter medium and slidable along a protruding tube of the housing when the filter element is installed in the housing.

4. A filter element for use in an oil filter housing, the assembly comprising:
a first end cap having a central opening;
a second end cap having a central opening;
a cylindrical filter medium joined to the first and second end caps;
the first end cap having a closure element that is disposed between the central opening and the periphery thereof and extending axially outward from the first end cap, the closure element having a finger portion axially extending outward from the outer end of the closure element;
a location adjustment mechanism disposed adjacent to the central opening of the first end cap, the mechanism having a location element disposed in the central opening of the first end cap;
the location element operative to engage an outer end of a tube of the housing in which the filter assembly is installed, and to move inward of the filter medium during installation of the filter element in the housing.

5. The filter element of claim 4 wherein the first end cap has a tubular section inwardly extending in the filter medium and in which the mechanism is disposed.

6. The filter element of claim 4 wherein the mechanism includes a normally open spring and wherein the location element is a ring which moves inward of the filter medium against the force of the spring during installation of the filter element in the housing.

7. The filter element of claim 5 wherein the mechanism includes a plurality of support elements joined to the tubular section of the first end cap.

8. The filter element of claim 4 wherein the closure element of the first end cap has a finger portion axially extending outward from the outer end of the closure element and operative to engage a stop in the filter housing thereby to limit rotation of the filter element in the housing.

9. The filter element of claim 8 wherein the closure element includes an end surface which inclines upward and terminates at the finger portion.

10. The filter element of claim 9 wherein the closure element includes a sealing ring around the outer end portion of the closure element and operative to seal a drain hole of the filter housing.
